(19) United States
(12) Patent Application Publication
(10) Pub. No.: US 2012/0114802 A1
(43) Pub. Date: May 10, 2012

(54) PROCESS FOR ADHERING AN EDIBLE PRINTED IMAGE TO A CHOCOLATE CONFECTION

(75) Inventors: Jordana LANGIOTTI SWANK, Hamburg, PA (US); Peter Machado, Harrisburg, PA (US)

(73) Assignee: THE HERSHEY COMPANY, Hershey, PA (US)

(21) Appl. No.: 12/942,121

(22) Filed: Nov. 9, 2010

(51) Int. Cl. A23G 1/54

(52) U.S. Cl. 426/87; 426/383

(57) ABSTRACT

A process is disclosed for adhering an edible printed image to a chocolate confectionery product. The process includes providing a transfer sheet having a transparent edible film applied thereon, printing a mirrored image on the transparent edible film using edible ink, applying a layer of a colloidal solution consisting essentially of titanium dioxide and a chocolate-compatible fat overlying the mirrored image. The colloidal solution forms an edible opaque layer with the mirrored image intermediate the transparent edible film and the edible opaque layer. The edible opaque layer is then adhered to a chocolate substrate, thereby affixing the image to the chocolate confectionery product.

### FIELD

This application is directed to confectionery products and more particularly to a process for adhering a printed image to a chocolate confection.

### BACKGROUND

The advent of edible inks for use in combination with traditional four color ink jet printers has led to the ability to print both simple and complex images for use in conjunction with food products, particularly sweets such as cookies, cakes and other iced products. Typically, such printing has been carried out by printing directly onto white icing sheets or onto rice paper that is subsequently applied to a white iced product.

Among the many limitations with current methods of placing images on food is that the ability to do so is significantly limited by the background color of the food on which the image is placed. That background color tends to be visible through the image even in cases in which thin materials, such as rice paper, are used, thereby limiting the number and types of food on which the image can be placed and still be visible in the manner intended, if at all. This issue is particularly problematic for chocolate which, because of its dark color, interferes significantly with the ability to view the image at the intended level of resolution.

U.S. Pat. No. 6,893,671 and U.S. Publication No. 2009/0081341 are each directed to methods of printing an image on chocolate in which an opacifier is included in an edible film, followed by printing the image directly onto the opacified film. Among the disadvantages of these methods is that the image is printed directly on the exposed surface of the opacified film, meaning that the image is subject to smearing or other unintended distortion resulting from handling.

EP 1 964 478 discloses the use of white chocolate in a mold to form a layer having a light background over which melted chocolate is poured. Among the disadvantages of this method is that the use of white chocolate is undesirable for several reasons, including that white chocolate has its own taste that can interfere with the taste of the overall chocolate product. The taste of the product should be the same regardless of whether or not the product bears a printed image. The taste of a chocolate product is a primary reason for consumer selection. For example, a Reese's® Peanut Butter Cup that tastes different to consumers because it contains white chocolate in order to allow for a printed image is unsatisfactory.

These and other drawbacks are found in current methods of forming images on chocolate products.

### SUMMARY

Exemplary embodiments are directed to methods of producing printed images on a chocolate confectionery product by providing an opaque background that both adheres the image to the chocolate and provides a light background to allow the image to be viewed at its intended quality and resolution, but without interfering with the taste, texture or other qualities of the chocolate confectionery product.

In one embodiment, a process for adhering an edible printed image to a chocolate confectionery product comprises providing a transfer sheet having a transparent edible film applied thereon, printing a mirrored image on the transparent edible film using edible ink, and applying a layer of a colloidal solution consisting essentially of titanium dioxide and a chocolate-compatible fat overlying the mirrored image to form an edible opaque layer. The mirrored image is intermediate the transparent edible film and the edible opaque layer. The method further includes adhering the edible opaque layer to a chocolate substrate which affixes the image to the chocolate confectionery product.

According to another embodiment, the mirrored image is printed on the transparent edible film using water-base edible ink, followed by spray applying a composition consisting essentially of cocoa butter or a cocoa butter equivalent and about 5% to about 24% by weight titanium dioxide as a molten colloidal solution at a temperature of about 40° C. to form an edible opaque layer. The mirrored image is intermediate the transparent edible film and the edible opaque layer, the transparent edible film and the edible opaque layer having a combined thickness less than about 1.0 mm. The edible opaque layer is adhered to a room temperature chocolate substrate containing cocoa solids by solidifying and tempering the colloidal solution on a surface of the chocolate substrate.

An advantage of certain embodiments is that a chocolate confectionery product can be obtained that has an edible image printed thereon in which the underlying chocolate does not interfere with the ability to view the image through the use of an edible opaque intermediate layer.

Another advantage is that the edible opaque layer also serves to adhere the image to the chocolate confectionery and does not interfere with its taste. Furthermore, the edible opaque layer is integrated into the surface of the chocolate confectionery, so that biting into or breaking the chocolate confectionery does not result in separation of the image and/or the edible opaque layer from the chocolate confectionery.

Other features and advantages of the present invention will be apparent from the following more detailed description of exemplary embodiments, taken in conjunction with the accompanying drawings which illustrate, by way of example, the principles of the invention.

### BRIEF DESCRIPTION OF THE DRAWING

FIGS. 1, 2, 3, 4 and 5 schematically illustrate sequential steps for adhering an edible printed image to a chocolate substrate in accordance with an exemplary embodiment.

FIG. 2a illustrates an isometric view of FIG. 2.

FIG. 6 illustrates a finished product manufactured in accordance with an exemplary embodiment.

### DETAILED DESCRIPTION OF EXEMPLARY EMBODIMENTS

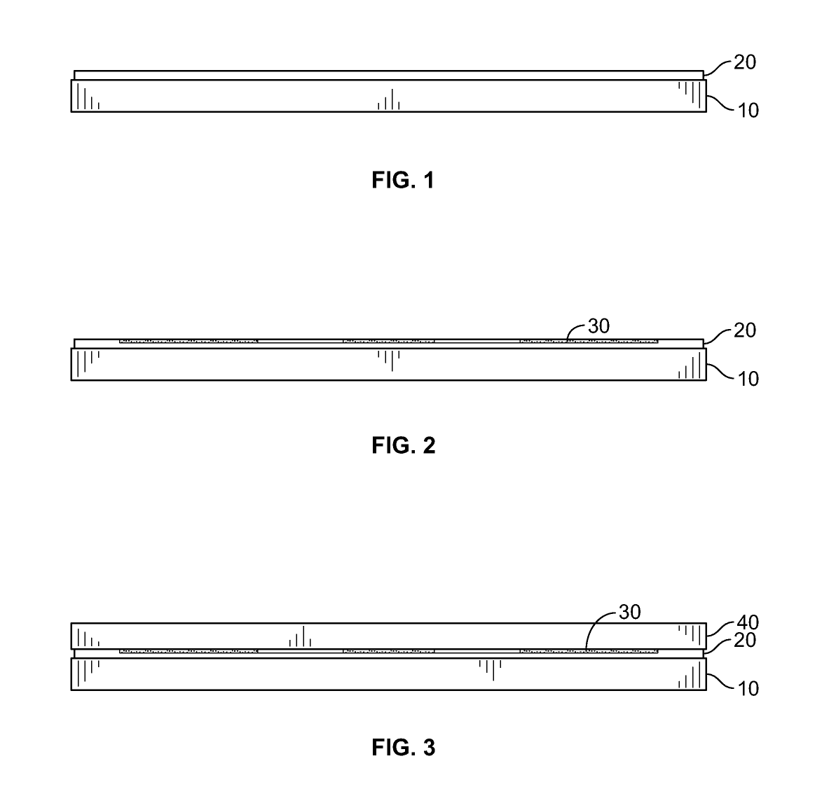

Turning to FIG. 1, a transfer sheet 10 is shown on which a transparent edible film 20 is formed. The transfer sheet 10 is any suitable plastic film material, such as acetate, and is preferably clear in order to be able to inspect the image that is subsequently printed on the transparent edible film 20 prior to being adhered to a chocolate confectionery product.

The transparent edible film 20 may be any edible, transparent film material on which an image is capable of being printed. The transparent edible film 20 typically includes a starch and may also include other ingredients such as sugar, gelatin and/or cocoa butter. Various transparent edible films 20 are known within the art and may be formulated and created on the transfer sheet 10; alternatively, previously formed edible film/transfer sheet combinations are commercially available and include, for example, the product known as a chocosheet.

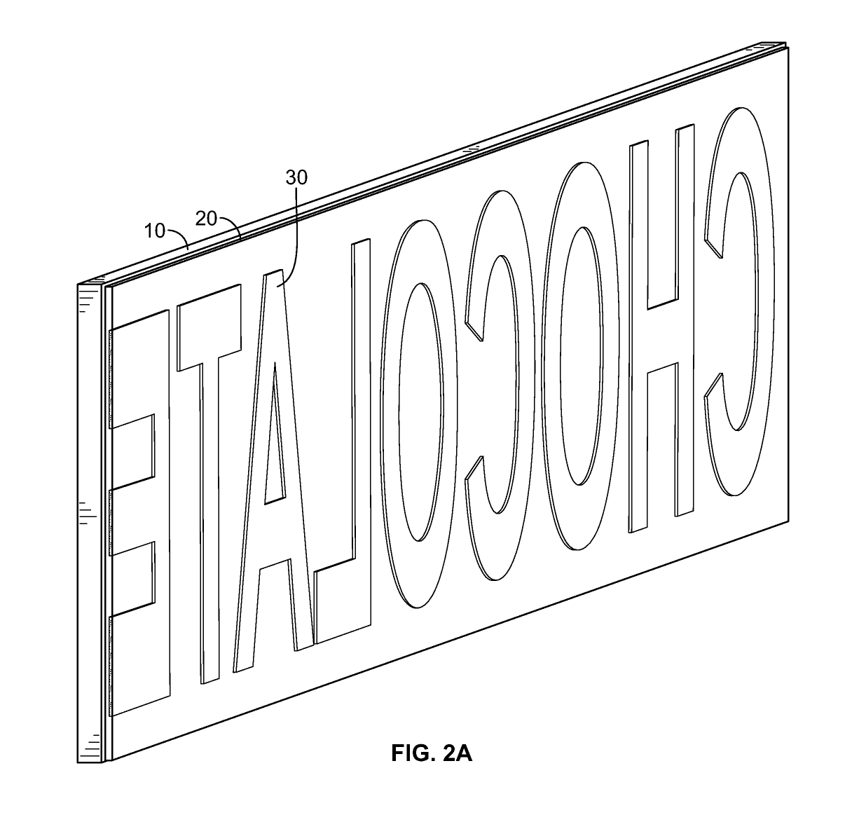

An image 30 is then printed on the transparent edible film 20 as illustrated in FIG. 2. The isometric view of FIG. 2a shows the image 30 is printed as a mirrored image because of the way in which it will ultimately be applied to the underlying chocolate through the use of the transfer sheet 10. One advantage realized as a result of the way in which the image is printed and applied in this manner is that the opposing surface of the transparent edible film 20—as well as the transfer sheet 10 prior to its removal—act to protect the image 30 from being altered by handling during manufacturing and shipping, so that the image remains pristine until eaten by the consumer.

The image 30 may be printed using any edible inks using any suitable printing device. Preferably, the edible inks are water based inks. Such water-base edible inks are commercially available and may readily be used in conventional four color ink jet printers to print highly resolved images of photographic quality. It will be appreciated that some of the ink that forms the image 30 is absorbed by the edible transparent film 20 in much the same way as when conventional inks are printed on paper.

Next, an edible opaque layer 40 is applied over the image 30 and the edible transparent film 20 as shown in FIG. 3. The edible opaque layer 40 should be white, which has the effect of creating a light background that prevents the brown color of the chocolate confectionery product to which the image will be adhered from distorting the colors and resolution of the image 30. It further has the effect of preventing the edible opaque layer 40 itself from introducing distortions to the image color, which may be present if the edible opaque layer 40 were other than white.

The edible opaque layer 40 is formed from a colloidal solution that consists essentially of titanium dioxide and a chocolate-compatible fat such as cocoa butter. Other chocolate-compatible fats that may be used in combination with or in lieu of cocoa butter include, for example, the fat blends that form the class of products known within the art as cocoa butter equivalents (CBEs), which are typically blends of shea butter and/or illipe butter with fractions of palm oil and include products sold under the tradenames Choclin, Coberine, Palmy MMSE, Palmy MM78 and Illexao, by way of example only.

By “consists essentially of” is meant that the colloidal solution includes titanium dioxide and one or more chocolate compatible fats, and that it may further include other additives provided those additional ingredients do not adversely affect the taste of the chocolate confectionery product or substantially increase the viscosity of the colloidal solution. Examples of ingredients that would adversely impact either or both of these characteristics include white chocolate, sugar, and milk solids.

In one embodiment, the edible opaque layer consists of titanium dioxide and a chocolate compatible fat; that is, the edible opaque layer has no ingredients other than titanium dioxide and the chocolate compatible fat.

The chocolate compatible fat provides a medium that enhances compatibility between the underlying chocolate confectionery product and the transparent edible film 20 and the inks used to print the image 30 on that film 20. The titanium dioxide is a white pigment that opacifies and whitens the colloidal solution. The titanium dioxide should be present in a sufficient amount to provide a suitably white background, which may in part depend on the type and/or color of the chocolate compatible fat that is used. Generally, the titanium dioxide is present as at least about 5% by weight of the colloidal solution, and in one embodiment is present from about 18% to about 24% by weight of the colloidal solution.

The colloidal solution is applied overlying the surface of the transparent edible film 20 on which the image 30 has been printed to the desired thickness to form the edible opaque layer 40. The colloidal solution is deposited as a liquid at a temperature above the melting point of the cocoa butter and/or any other chocolate-compatible fats that are present in the colloidal solution. Preferably, the edible opaque layer 40 is created by spray applying the colloidal solution at a temperature of around 40° C. However, any method may be used and, for example, the colloidal solution may be poured or printed onto the edible transparent film 20.

The transparent edible film 20 on which the image 30 is printed can be of any thickness that does not interfere with its transparency or the ability to view the image 30 through it. However, the transparent edible film 20 should also be very thin so that it does not interfere with the texture or taste of the chocolate confectionery product with which it is employed. Likewise, the edible opaque layer 40 should be thick enough to provide the intended effect of masking the dark color of the underlying chocolate, but still be sufficiently thin so that like the transparent edible film 20, it does not interfere with the texture or taste of the chocolate confectionery product.

The combined thickness of the transparent edible film 20 and the edible opaque layer 40 is typically less than about 0.4 mm, with the transparent edible film 20 having a thickness of about 0.05 mm to about 0.1 mm, and the edible opaque layer 40 having a thickness typically in the range of about 0.1 mm to about 0.2 mm, although in some embodiments the thickness may be up to about 0.3 mm or greater.

Thicknesses in these ranges have the further advantage of permitting the layers of the transparent edible film 20 and edible opaque layer 40 to become integrated with the chocolate confectionery and resist delamination when the product is broken. For example, the chocolate confectionery product may be broken or cut in order to share, or it may be broken when bitten. In any case, it is desirable for the transparent edible film 20 and edible opaque layer 40 to cleave in the same manner as the chocolate confectionery product. This gives the consumer the reassuring conclusion that the chocolate confection bearing an image 30 is otherwise the same as an identical product that does not have an image.

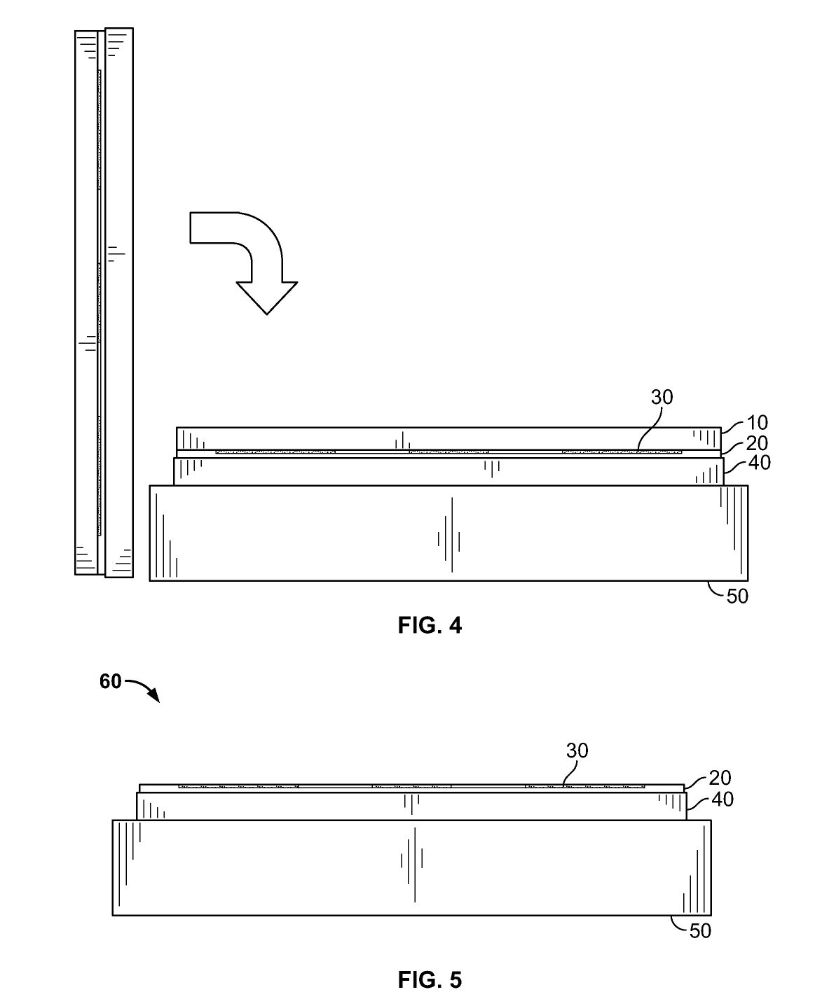

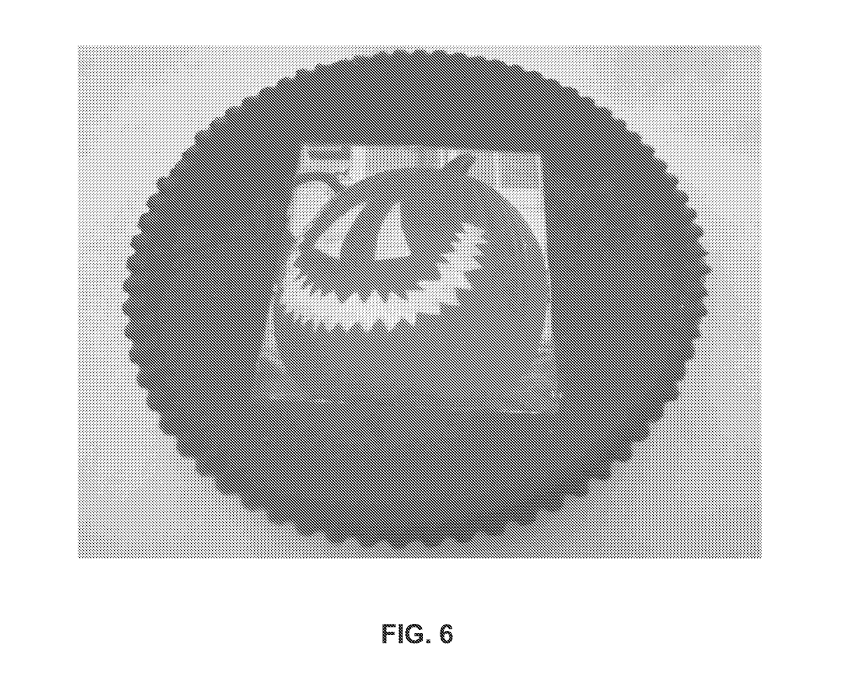

Turning to FIG. 4, an assembly formed of the transfer sheet 10, transparent edible film 20 on which the image 30 is printed, and the opaque edible layer 40 is applied to a chocolate substrate 50 by adhering the edible opaque layer 40 to the chocolate substrate 50. This creates a finished chocolate confectionery product 60 bearing the image 30 visible through the transparent edible film 20. The product 60 can be consumed following removal of the transfer sheet 10 (FIG. 5). The transfer sheet 10 may be removed as the final manufacturing step before packaging. Alternatively, in some embodiments the transfer sheet 10 may be left in place to ultimately be removed by the consumer prior to eating the chocolate confectionery product 60.

The chocolate substrate 50 can be any chocolate confectionery product 60 on which it is desired to print an image. Examples of suitable chocolate substrates include solid chocolate, chocolate bars and other confections containing nuts, crisped rice, or other ingredients, as well as peanut butter cups and other chocolate-covered confections including nougats, mints, caramel, fruit and the like. Furthermore, it will be appreciated that while the surface of the chocolate substrate 50 to which the image 30 is applied is typically a flat surface, exemplary embodiments may be used with chocolate substrates having any surface shape or surface texture to which the transparent edible film 20 and the edible opaque layer 40 can conform upon application to adhere the image 30 to the chocolate substrate 50.

All types of chocolate are contemplated as being within the scope of the present invention for use in the chocolate substrate 50 of the chocolate confectionery product. Typically, the chocolate is one which contains cocoa solids and thus has a deep brown or black color, and in most cases can be categorized as either milk chocolate or dark chocolate.

An advantage of exemplary embodiments is that the edible opaque layer 40 not only serves as a background to ensure the image retains its full panoply of color even on a dark background, but also acts to adhere the image 30 to the chocolate substrate 50. Returning to FIG. 4, in one embodiment, the edible opaque layer 40 (along with the transparent edible film 20, the underlying transfer sheet 10, and the image 30 printed on the transparent edible film 20), is applied to the chocolate substrate 50 shortly after application to the transparent edible film, while the edible opaque layer 40 is still molten (i.e., melted). Thus, as the colloidal solution forming the edible opaque layer 40 cools and solidifies, it is in contact with the chocolate substrate 50 and fuses to the surface of the chocolate substrate 50 to form an integrated interface between the two.

Preferably, the chocolate substrate 50 is a room-temperature solid at the time the edible opaque layer 40 is formed. The application of the molten colloidal solution to the solidified chocolate substrate 50 results in tempering of the colloidal solution as it cools. The tempering provides the desired crystalline structure in the cocoa butter or other chocolate-compatible fat, thereby producing a substantially uniform texture between the edible opaque layer 40 and the chocolate substrate 50 and resists separation between the layers.

According to another embodiment, the surface of the chocolate substrate 50 may also be warmed at the time the edible opaque layer 40 is formed, so that the surface of the chocolate substrate 50 and the edible opaque layer 40 are both molten at the time they are adhered to one another.

According to yet another embodiment, the edible opaque layer 40 is cooled and solidified after being applied to the transparent edible film 20. Prior to its application to the chocolate substrate 50 to adhere the image 30 thereto, either or both of the edible opaque layer 40 and the surface of chocolate substrate 50 are subsequently warmed, contacted with one another, and then allowed to cool again, to thereby become integrated at the interface of the two surfaces. This may be advantageous, for example, where the process takes place in discrete steps distant in time and/or location.

FIG. 6 illustrates a chocolate confectionery product 60 formed in accordance with the process described herein in which an edible opaque layer was formed from a colloidal solution consisting of a cocoa butter equivalent (obtained as Palmy MMSE from Fuji Oil Co.) and 5% by weight titanium dioxide sprayed onto a transparent edible film to form the edible opaque layer. The image 30 was adhered to a chocolate substrate 50 by applying the assembly containing the transfer sheet, transparent edible image on which a mirrored version of the image was printed, and the edible opaque layer. As shown, the edible opaque layer is fully concealed by the image 30, although in some embodiments the edible opaque layer may be used to frame the image and/or the design of the image be such that includes open spaces that reveal portions of the underlying edible opaque layer.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A process for adhering an edible printed image to a chocolate confectionery product comprising:
providing a transfer sheet having a transparent edible film applied thereon;
printing a mirrored image on the transparent edible film using edible ink;
applying a layer of a colloidal solution consisting essentially of titanium dioxide and a chocolate-compatible fat overlying the mirrored image to form an edible opaque layer such that the mirrored image is intermediate the transparent edible film and the edible opaque layer; and
adhering the edible opaque layer to a chocolate substrate, thereby affixing the image to the chocolate confectionery product.

2. The process of claim 1, wherein the chocolate-compatible fat includes cocoa butter or a cocoa-butter equivalent.

3. The process of claim 1, wherein the step of applying comprises spraying the colloidal solution as a liquid onto the mirrored image.

4. The process of claim 3, wherein the step of adhering comprises solidifying the liquid colloidal solution on a surface of the chocolate substrate to form an integrated interface of the edible opaque layer and the chocolate substrate.

5. The process of claim 1, further comprising the step of removing the transfer sheet from the transparent edible film after the step of adhering.

6. The process of claim 1, wherein the step of adhering comprises contacting the edible opaque layer to a melted surface of the chocolate substrate and cooling the chocolate substrate surface to form an integrated interface of the edible opaque layer and the chocolate substrate.

7. The process of claim 1, wherein the chocolate substrate contains cocoa solids.

8. The process of claim 1, wherein the mirrored image is printed using water-base edible inks.

9. The process of claim 1, wherein the transparent edible film further comprises sugar, cocoa butter and gelatin.

10. The process of claim 1, wherein the colloidal solution contains at least about 5% by weight titanium dioxide.

11. The process of claim 1, wherein the colloidal solution contains in the range of about 18% to about 24% by weight titanium dioxide.

12. The process of claim 1, wherein the colloidal solution is applied to form an edible opaque layer having a thickness in the range of about 0.1 mm to about 0.2 mm.

13. The process of claim 12, wherein the transparent edible film and the edible opaque layer have a combined thickness of about 0.3 mm or less.

14. The process of claim 1, wherein the step of adhering comprises tempering the colloidal solution.

15. The process of claim 1, wherein the edible opaque layer is fully concealed by the printed image after the edible opaque layer is adhered to the chocolate substrate.

16. The process of claim 1, wherein the colloidal solution consists of chocolate compatible fat and titanium dioxide.

17. A process for adhering an edible printed image to a chocolate confectionery product comprising:
providing a transfer sheet having a transparent edible film applied thereon, the transparent edible film containing a starch;
printing a mirrored image on the transparent edible film using water-base edible ink;
spray applying a composition consisting essentially of cocoa butter or a cocoa butter equivalent and about 5% to about 24% by weight titanium dioxide as a molten colloidal solution at a temperature of about 40° C. to form an edible opaque layer such that the mirrored image is intermediate the transparent edible film and the edible opaque layer, the transparent edible film and the edible opaque layer having a combined thickness less than about 1.0 mm; and
adhering the edible opaque layer to a room temperature chocolate substrate containing cocoa solids by solidifying and tempering the colloidal solution on a surface of the chocolate substrate, thereby affixing the image to the chocolate confectionery product.

18. The process of claim 17, wherein the edible opaque layer is fully concealed by the printed image after the edible opaque layer is adhered to the chocolate substrate.

19. A chocolate confectionery product comprising:
a chocolate substrate;
an edible opaque layer consisting essentially of titanium dioxide and a chocolate-compatible fat overlying a portion of the chocolate substrate, the titanium dioxide present in at least about 5% by weight of the edible opaque layer; and
a transparent edible film, the transparent edible film bearing a printed image intermediate the transparent edible film and the edible opaque layer.

20. The chocolate confectionery product of claim 19, wherein the edible opaque layer has a thickness in the range of about 0.1 mm to about 0.2 mm.

21. The chocolate confectionery product of claim 20, wherein the transparent edible film has a thickness in the range of about 0.05 mm to about 0.1 mm.

22. The chocolate confectionery product of claim 19, further comprising a transfer sheet overlying the transparent edible film.
